(19) United States
(12) Patent Application Publication
(10) Pub. No.: US 2026/0259731 A1
(43) Pub. Date: Sep. 3, 2026

(54) INSTRUCTION SET ARCHITECTURE FOR MATRIX OPERATIONS

(71) Applicant: Google LLC, Mountain View, CA (US)

(72) Inventor: Jonathan Lindsey Tate, Bertram, TX (US)

(21) Appl. No.: 18/869,530

(22) PCT Filed: May 25, 2023
(86) PCT No.: PCT/US2023/023570

§ 371 Date: Nov. 26, 2024

Related U.S. Application Data
(60) Provisional application No. 63/346,122, filed on May 26, 2022.

(51) Int. Cl. G06F 9/30

(52) U.S. Cl. CPC G06F 9/30036; G06F 9/3001; G06F 9/30189

(57) ABSTRACT

Methods, systems, and apparatus, including computer programs encoded on computer storage media, for reinterpreting vector instructions as matrix instructions. One of the methods is performed by a processor implementing an instruction set architecture having an instruction for setting a configuration register of the processor that controls whether vector instructions are interpreted as vector or matrix instructions. The instruction is executed to set the configuration register. Then, when one or more vector instructions are received, based on information set in the configuration register the one or more vector instructions are reinterpreted as matrix instructions.

### BACKGROUND

This specification relates to computer processors and instruction set architectures.

An instruction set architecture (ISA) is a model of the behavior of a particular family of processors that does not depend on the specific hardware implementation or microarchitectural details of any of the processors in the family. ISAs commonly define the types of instructions that can be executed, what fields the instructions have, the names of configuration and data registers, data types, and other features of the family of processors. ISAs provide an abstraction that allows processors having different physical characteristics and capabilities to execute the same software. Thus, hardware that implements the ISA can be upgraded to newer or more powerful versions without changing the software.

Some ISAs define processor support for vector operations. Vector operations operate on vectors of arbitrary length and spare the software developer or compiler from explicitly representing the iteration over the elements of the vectors. Instead, a processor implementing the ISA will automatically iterate over the vectors according to a vector size that can be specified at run time rather than being hard coded. Processors implementing such vector instructions often utilize specialized vector processing hardware components having multiple cores that are used to parallelize the vector operations.

The ISA defining vector operations can define a set of special vector registers that are used to support the vector operations. The vector instructions can then reference the vector registers as operands. The implementation of the vector operations will effectuate the vector instruction without the software specifying explicit iteration instructions. To use such vector operations, the software can specify various configuration information about the vectors and their elements, such as the number of elements in a vector, as well as the size and type of each element in the vectors.

However, despite vector operations providing enormous flexibility for single dimensional datasets, such arbitrary length vector operations tend to be inefficient at processing multi-dimensional datasets, such as matrices. One problem is that because matrices have indices for two dimensions, it is highly possible that the processor can run out of vector register resources when trying to iterate over a two dimensional matrix of arbitrary size. When this happens, other mitigations that slow down computational performance have to be invoked, such as the slow process of writing data out to memory to free up resources in the vector registers.

This phenomenon is a substantial bottleneck for machine learning operations, which typically require very intensive matrix computation.

### SUMMARY

This specification describes an instruction set architecture (ISA) having instructions that are particularly useful for, and improve the performance of, matrix operations and related machine learning applications. To do so, the ISA defines a new configuration register (CR) for matrix operations and an accompanying set of instructions for setting values of the CR.

Setting the values of the CR for matrix operations effectively overrides the meaning of vector multiplication instructions so that the instructions cause the processor to perform matrix multiplication arithmetic. In doing so, the processor implementing the ISA will reinterpret vector register operands as vectors of small matrices rather than vectors of single elements. For example, instead of the processor operating on 256-element vectors of scalar values, the processor can reinterpret the data as a quarter-length vector of 2×2 matrices.

This arrangement provides for significantly higher computational intensity without fundamentally altering the existing vector instructions.

Particular embodiments of the subject matter described in this specification can be implemented so as to realize one or more of the following advantages. The instruction set architecture described in this specifies improves the performance of processors that perform matrix operations, which makes such processors more efficient and faster at performing machine learning applications that rely on such matrix applications. The matrix extensions are also fully backward compatible so that older software written for vector-only operations will still execute on newer processors that implement the matrix extensions. According to an embodiment, there is provided a processor configured to implement an instruction set architecture having an instruction that in operation sets a configuration register of the processor with one or more values that cause the processor to reinterpret one or more vector instructions as matrix instructions.

The matrix extensions are themselves extensible with no requirements on the processor implementation to use a particular matrix size. Furthermore, in heterogeneous processing environments with performance and efficiency cores, it is conceivable that the cores could support different matrix sizes as long as the OS is careful not to migrate threads from a core with higher performance to those of lower performance during matrix processing.

The processor may be configured to perform vector arithmetic on a sequence of matrices to reinterpret the vector instructions as matrix instructions.

Reinterpreting a vector instruction as a matrix instruction may comprise reinterpreting data in a vector register as a sequence of matrices.

Reinterpreting the data in a vector register as a sequence of matrices may comprise reinterpreting the data in the vector register as a sequence of 2×2, 4×4, 8×8, or 16×16 matrices. The configuration register may have a field representing a matrix width.

The field representing the matrix width may represent an exponent N for a matrix having a width given by 2\hat{ }N.

The configuration register may have a field representing a matrix data order.

The configuration register may have a field representing a widening mode.

The configuration register may have a field representing a horizontal accumulation span, wherein the processor is configured to interpret a value of the horizontal accumulation span as a directive to use a pre-add instruction during a multiply-accumulate operation.

The instruction set architecture may specify an enable bit in a second different configuration register that specifies whether the processor will interpret the one or more vector instructions to be referencing vector inputs or matrix inputs.

According a further embodiment there is provided a method performed by a processor implementing an instruction set architecture having an instruction for setting a configuration register of the processor that controls whether vector instructions are reinterpreted as matrix instructions, the method comprising: executing the instruction to set the configuration register; receiving one or more vector instructions; and based on information set in the configuration register, reinterpreting the one or more vector instructions as matrix instructions.

There is also provided one or more computer storage media encoded with instructions of an instruction set architecture having an instruction for setting a configuration register to control whether a processor implementing the instruction set architecture will reinterpret vector instructions as matrix instructions, wherein the instructions being executed by the processor implementing the instruction set architecture causes the processor to perform operations comprising: executing the instruction to set the configuration register; receiving one or more vector instructions; and as a result, reinterpreting the one or more vector instructions as matrix instructions.

The following optional features may be applied to the above method or computer storage media.

Reinterpreting the vector instructions as matrix instructions may comprise performing vector arithmetic on a sequence of matrices.

Reinterpreting a vector instruction as a matrix instruction may comprise reinterpreting data in a vector register as a sequence of matrices.

Reinterpreting the data in a vector register as a sequence of matrices may comprise reinterpreting the data in the vector register as a sequence of 2×2, 4×4, 8×8, or 16×16 matrices. Executing the instruction may set a field in the configuration register representing a matrix width.

The field representing the matrix width may represent an exponent N for a matrix having a width given by 2\hat{ }N.

Executing the instruction may set a field in the configuration register representing a matrix data order.

Executing the instruction may set a field in the configuration register representing a widening mode.

Executing the instruction may set a field in the configuration register representing a horizontal accumulation span, and further comprising interpreting a value of the horizontal accumulation span as a directive to use a pre-add instruction during a multiply-accumulate operation.

The instruction set architecture may specify an enable bit in a second different configuration register that specifies whether the processor will interpret the one or more vector instructions to be referencing vector inputs or matrix inputs.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example processor for implementing an example instruction set architecture (ISA).

FIG. 2A illustrates an example interpretation of a matrix multiplication instruction.

FIG. 2B illustrates an example operation of the matrix multiplication instruction of FIG. 2A.

FIG. 2C illustrates an example result of the matrix instruction of FIG. 2A.

FIG. 3 is a flow chart that illustrates an example process 300 for reinterpreting vector instructions as matrix instructions.

### DETAILED DESCRIPTION

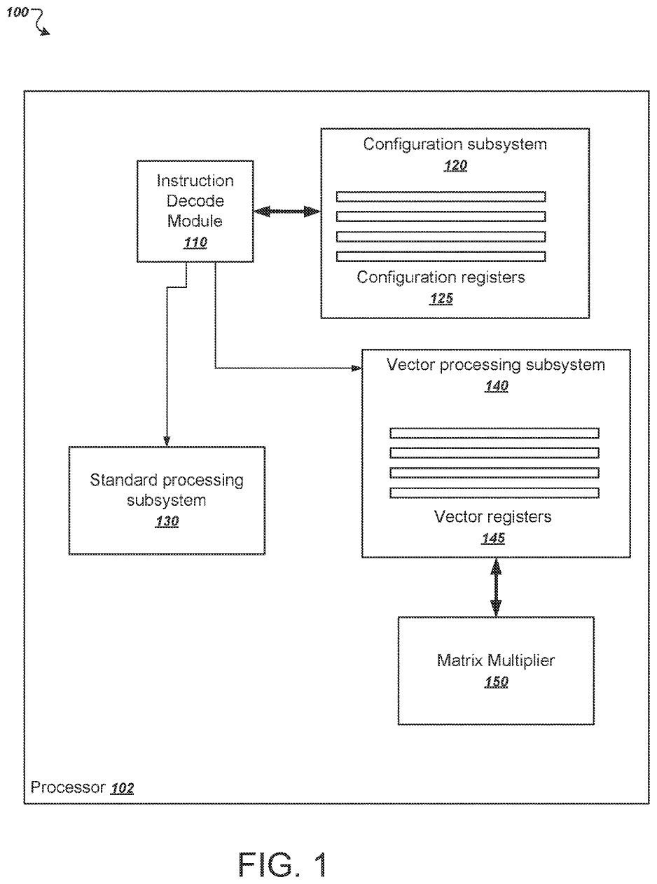

FIG. 1 illustrates an example processor 102 for implementing an example instruction set architecture (ISA). The processor 102 includes an instruction decode module 110, a standard processing subsystem 130, a configuration subsystem 120, a vector processing subsystem 140, and a matrix multiplier 150. These are example components that can be used to implement the ISA described in this specification.

The processor 102 is configured to implement the ISA described in this specification. The ISA can include multiple instructions. Each instruction can cause the processor to perform one or more operations. The ISA can have one or more matrix instructions that cause the processor 102 to perform matrix operations. The ISA can include an instruction that sets a configuration register 125 of the processor 102 with one or more values that cause the processor to reinterpret one or more vector instructions as matrix instructions. A matrix instruction differs from a vector instruction in that a matrix instruction's operands are two-dimensional data sets and a vector instruction's operands are one dimensional data sets.

The instruction decode module 110 has logic circuitry that can decode each of the instructions in the ISA and can cause the subsystems of the processor 102 to perform the operations necessary to implement the instruction.

The ISA can have one or more vector instructions that cause the processor 102 to perform vector or matrix operations. The ISA also has instructions to set configuration registers to control such vector or matrix operations. The instruction decode module 110 can route configuration register instructions to the configuration subsystem 120 and can route the vector instructions to the vector processing subsystem 140. The vector processing subsystem 140 can include one or more vector registers 145 and other appropriate hardware for implementing the vector instructions. Each vector register can hold data for vector processing.

A vector instruction is an instruction that causes the processor 102 to perform one or more vector operations. For example, a vadd instruction, when executed by the vector processing subsystem 140, can populate a vector register with the element-by-element addition of two other vector registers. In some implementations, a processor can execute vector instructions using parallel processing hardware. For example, the vector processing subsystem 140 can have arrays of processing elements that can perform the operations of a vector addition instruction in parallel. Thus, a vector instruction can result in the processor 102 operating on multiple pairs of data specified by operands of an instruction. The vector registers 145 can for example store a one-dimensional array of integers, logical values, characters, or floating-point numbers, to name just a few examples. A vector instruction can operate on vectors of arbitrary length.

The vector instructions can include instructions to perform a vector operation. In some implementations, the vector instructions can reference the vector registers 145 as operands. To use such vector operations, the configuration registers 125 store data that specifies various configuration information about the vectors and their elements, such as the number of elements in a vector, as well as the size and type of each element in the vectors.

For example, the ISA can include an instruction to set a vector register with data describing an M length vector of ones, an instruction to set a vector register with data describing an M length vector of numbers 1 through M, and an instruction to multiply the two vectors. The vector processing subsystem can set the operands in a vector register to represent a vector of ones and set the operands in another vector register to represent a vector of numbers 1 through M. The vector processing subsystem 140 can then multiply the two vectors together.

The ISA can also have an instruction that sets a configuration register 125 of the processor 102 to reinterpret one or more vector instructions as matrix instructions. A matrix instruction is an instruction that causes the processor to perform operations on two-dimensional data sets of arbitrary size. The instruction decode module 110 sends the instruction to a configuration subsystem 120. The configuration subsystem 120 includes one or more configuration registers 125. For one or more of the configuration registers 125, the ISA can define a configuration register (CR) for matrix operations and an accompanying set of instructions for setting values of the CR.

Setting the values of the CR 125 for matrix operations effectively overrides the meaning of vector multiplication instructions so that the instructions cause the processor to perform matrix multiplication arithmetic. In doing so, the processor implementing the ISA will reinterpret vector register operands as vectors of small matrices rather than vectors of single elements. For example, instead of the processor operating on a vector of scalar values, the processor can reinterpret the data as a quarter-length vector of 2×2 matrices.

An example of a configuration register for matrix operations will now be described. The example configuration register has a name vtypex, which has the following fields and abbreviations: a selected matrix width (vsmw), a matrix data order (vmdo), a widening mode (vnwmode), and a horizontal accumulation span (vhspan).

The selected matrix width field represents the width of the matrix that will be referenced by a vector instruction. In some implementations, the selected matrix width is specified as an exponent in the expression 2\hat{ }N. In other words, a value of 0 represents a width of 1, a value of 4 represents a width of 16, and so on. For example, if the vector registers 145 of the processor 102 hold 16 values, a selected matrix width of 0 would be interpreted as 16 scalar values, a selected matrix width of 1 would be interpreted as the vector register holding four 2×2 matrices, and a selected matrix width of 2 would be interpreted as the vector register holding one 4×4 matrix.

The matrix data order field specifies whether the arrangement of values in the vector register is row-major or column-major ordering. This capability effectively provides a free transpose when performing matrix multiplications. In some implementations, the matrix data order field can be set to specify z-ordering or Morton ordering, which effectively interleaves the x and y coordinates.

The widening mode field specifies the bit width of the computation output. In a typical multiplication operation of two 8-bit numbers, the result can be up to a dual-widened 16-bit number. However, 16 bits is often insufficient for machine learning applications that rely on accumulations. Therefore, setting the widening model field can cause the processor to allocate more bits to the output result than would ordinarily be the case. Thus, the result of multiplying two 8 bit numbers can be stored in a quad-widened 32- bit output register. Conversely, the widening mode field can also be used to narrow the output, for example, when the result needs to be shifted and truncated.

The horizontal accumulation span field affects the operation of matrix multiply operations. In effect, this field provides for a second addition step after the multiply but prior to the accumulation. This functionality ameliorates one downside of output quad-widening, which is that you have to write an output to two times as many output registers as there were inputs, which can be complex to implement in hardware. Instead, after a multiply, this field specifies a horizontal reductive sum for groups of matrices, e.g., groups of 2, groups of 4, or groups of 8, which reduces the number of outputs that need to be written.

The ISA can also specify an enable bit (veml) that controls whether vector instructions are being executed in vector mode or matrix mode. In some implementations, the enable bit is a value in second different configuration register 125 that controls vector operations. Placing the enable bit in that second register allows full backward compatibility with previous programs that did not contemplate the matrix extension.

In order to set the value of the matrix configuration register, the ISA can define a new instruction for doing so, e.g., an instruction named vsetvxi. The new instruction can have a field that specifies the values to be written to the matrix configuration register, and software can change these values as needed at runtime.

When a vector operation is encountered with the enable bit set, the processor 102 will thus treat the input operands as representing groups of matrices rather than vectors of scalars.

If the enable bit indicates that vector instructions are being executed in matrix mode, the instruction decode module 110 sends the instructions to the matrix multiplier 150. The matrix multiplier 150 includes appropriate hardware to execute matrix arithmetic on the vector register operands using the data in the vector registers 145 e.g., process the data in the register as a sequence of matrices and multiplying the matrices. If the enable bit indicates that vector instructions are being executed in vector mode, the instruction decode module 110 sends the instructions to be executed by the vector processing subsystem 140 instead.

The ISA can also have one or more standard (e.g., non-vector and non-matrix) instructions such as loads, stores, adds, and branches. The instruction decode module 110 can route the standard instructions to the standard processing subsystem 130. The standard processing subsystem 130 includes appropriate hardware to implement the standard instructions. For example, the standard processing subsystem 130 can execute a load instruction by issuing a command to memory for the data located at a particular address specified by the load instruction.

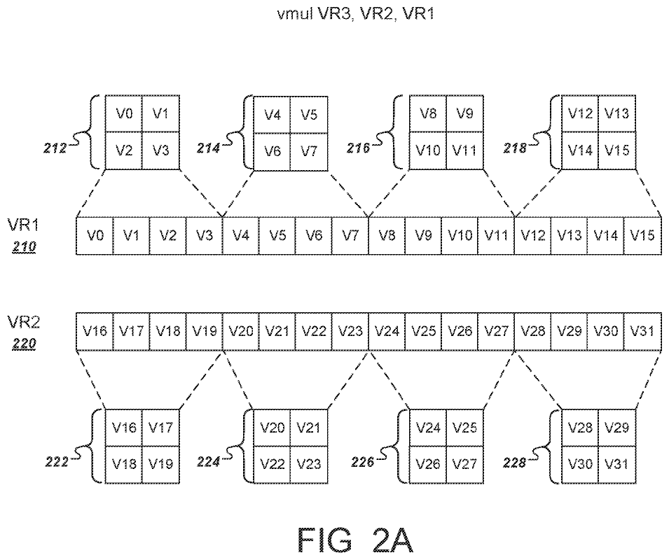

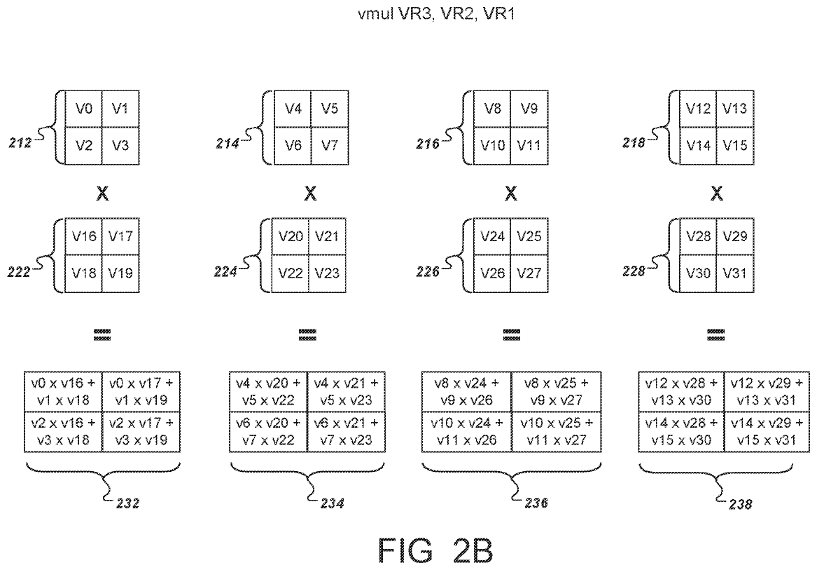

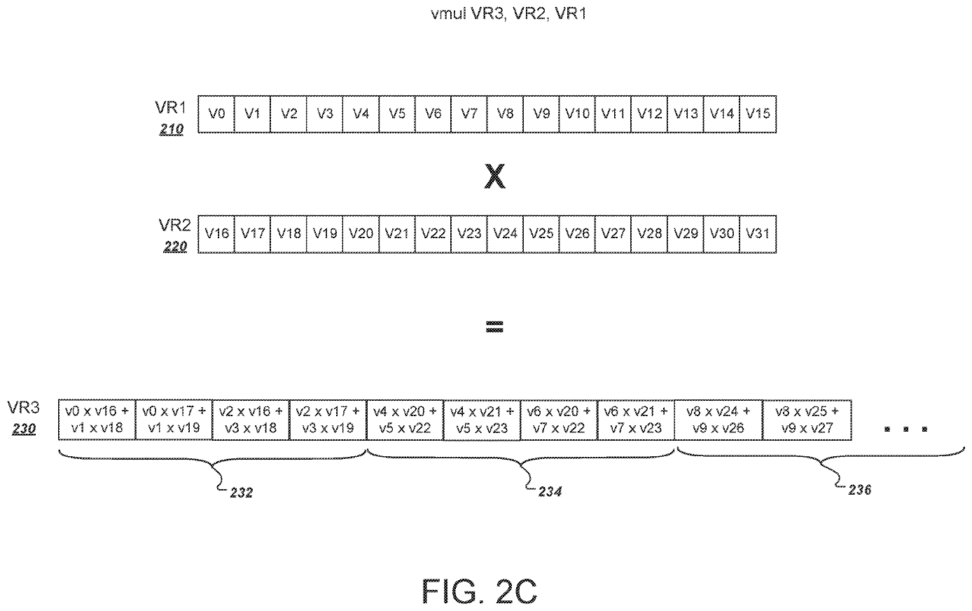

FIG. 2A illustrates an example interpretation of a matrix multiplication instruction. The matrix multiplication instruction can be implemented on any appropriate processor that implements the ISA described in this specification, e.g., the processor 102 of FIG. 1.

In this example, the processor has two vector registers with sixteen elements each. The first vector register 210 includes elements V0, V1, V2, . . . , V15 and the second vector register 220 includes elements V16, V17, V18, . . . , V31. For example, the elements can store data representing integers or floating point numbers.

With the appropriate configuration registers set, the processor can be configured to interpret instructions in matrix mode rather than vector mode. The processor can be configured to interpret vector register operands as vectors of matrices of a specified size. The processor can reinterpret the vector register operands as vectors of matrices of the specified size rather than vectors of single scalar elements. In this example, the processor can reinterpret the data as a vectors of 2×2 matrices rather than vectors of length 16 of single elements.

The matrix width can be specified by a mathematical expression. In some implementations, the matrix width is specified as an exponent in the expression 2\hat{ }N. More specifically, a value of 0 represents a width of 1, a value of 4 represents a width of 16, and so on. In this example, the vector registers hold 16 values. Thus, a selected matrix width of 1 would be interpreted as each vector register holding four 2×2 matrices.

In this example, the first four elements of the first vector register 210 are interpreted as a 2×2 matrix 212. Each position in a matrix can be represented as (r, c) where r ranges from 0 to total rows −1 and c ranges from 0 to total columns −1. In this example, r ranges from 0 to 1 and c also ranges from 0 to 1. The processor interprets the matrix 212 to have element V1 in the (0,0) position, element V2 in the (0, 1) position, element V3 in the (1, 0) position and element V4 in the (1,1) position.

The processor can similarly interpret the remaining elements of the first vector register 210 into three more 2×2 matrices 214 (for elements V4 to V7), 216 (for elements (V8 to V11), and 218 (for elements V12 to V15). The processor can also interpret the elements of the second vector register 220 in the same way into four 2×2 matrices 222 (for elements V16 to V19), 224 (for elements V20 to V23), 226 (for elements V24 to V27), and 228 (for elements V28 to V31). In this example, the processor receives a matrix instruction. The matrix instruction reads ‘vmul VR3, VR2, VR1’. This instruction can be decoded to instruct that the processor should interpret the vector registers as storing matrices having properties defined by the configuration registers, multiply the elements of the first vector register 210 (i.e. VR1) by the elements of the second vector register 220 (i.e. VR2), and store the result in a third vector register 230 (i.e. VR3).

FIG. 2B illustrates an example operation of the matrix multiplication instruction of FIG. 2A. The matrix multiplication instruction can be implemented on a processor, e.g., the processor 102 of FIG. 1.

Because the processor is configured to interpret instructions in matrix mode in this example, the processor can interpret the vector registers 210 and 220 as vectors of 2×2 matrices. The processor can interpret the matrix instruction ‘vmul VR3, VR2, VR1’ as performing matrix multiplication between the matrices of the first vector register 212, 214, 216 and 218 and the matrices of the second vector register 222, 224, 226, and 228.

The processor can multiply the first matrix 212 of the first vector register 210 by the first matrix 222 of the second vector register 220. The matrix 212 has V0 in the (0,0) position, V1 in the (0,1) position. V2 in the (1,0) position, and V4 in the (1,1) position. The matrix 222 has V16in the (0,0) position, V17 in the (0,1) position. V18 in the (1,0) position, and V19 in the (1,1) position.

The result of multiplying a 2×2 matrix 212 by a 2×2 matrix 222 is another 2×2 result matrix 232. After matrix multiplication is performed, the (0,0) position of the result matrix 232 can contain the result of V0×V16+V1×V18. The (0,1) position of the result matrix 232 contains the result of V0×V17+V1×V19. The (1,0) position of the result matrix 232 contains the result of V2×V16+V3×V18. The (1,1) position of the result matrix 232 contains the result of V2×V17+V3×V19.

The processor can multiply each remaining matrix in the first vector register 210 by the matrix of the same index in the second vector register 220 to produce a resulting matrix. Specifically, the processor can multiply the second 2×2 matrix of the first vector register 214 by the second 2×2 matrix of the second vector register 224 to produce a resulting 2×2 matrix 234. Similarly, the processor can multiply the matrix 216 by the matrix 226 to produce the resulting matrix 236 and the matrix 218 by the matrix 228 to produce the resulting matrix 238.

FIG. 2C illustrates an example result of the matrix instruction of FIG. 2A. The matrix multiplication instruction can be implemented on a processor, e.g., the processor 102 of FIG. 1. The processor can interpret the matrix instruction ‘vmul VR3, VR2, VR1’ as performing matrix multiplication between matrices of the first vector register 210 and matrices of the second vector register 220 and store the results in a third vector register 230. The third vector register 230 is of the same dimensions as the first 210 and second 220 vector registers.

In this example, the third vector register 230 is a vector of 16 elements. The third vector register 230 stores the values of the resulting matrices of the vector multiplication operations 232, 234,236, and 238. A first result matrix 232 is the result of multiplying the first 2×2 matrix of the first vector register 210 and the first 2×2 matrix of the second vector register 220. The elements of the first result matrix 232 populate the first four elements of the third vector register 230. Specifically, the first element of the third vector register 230 is the (0,0) index of the first result matrix 232, e.g., V0×V16+V1×V18. The second element of the third register is the (0,1) index of the first result matrix 232, and the third and fourth elements are populated by the (1,0) and (1,1) indices respectively.

In this pattern, the elements of the second result matrix 234 populate the fifth through eight elements of the third vector register 230. The next four elements are populated by the elements of the third result matrix 236 and the last four elements are populated by the elements of the fourth resulting matrix 238. Thus, the four resulting matrices are represented as a third vector register 230.

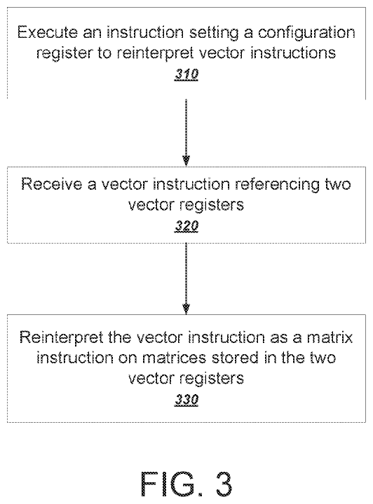

FIG. 3 is a flow chart that illustrates an example process 300 for reinterpreting vector instructions as matrix instructions. The process 300 can be performed by a processor e.g., the processor 102 of FIG. 1.

The processor executes an instruction that sets a configuration register to reinterpret vector instructions as matrix instructions (step 310). Setting the configuration register for matrix operations effectively overrides the meaning of vector multiplication instructions so that the instructions cause the processor to perform matrix multiplication arithmetic. In doing so, the processor will reinterpret vector register operands as vectors of matrices rather than vectors of single elements.

The configuration instruction can relate to the matrix width. In some implementations, executing the instruction sets a field in the configuration register that represents a matrix width. The matrix width field can represent the width of the matrix that will be referenced by a vector instruction. In some implementations, the selected matrix width is specified as an exponent in the expression 2\hat{ }N.

The configuration instruction can relate to the matrix data order. In some implementations, executing the instruction sets a field in the configuration register representing a matrix data order. The matrix data order field can specify whether the arrangement of values in the vector register is row-major or column-major ordering. In some implementations, the matrix data order field can be set to specify z-ordering or Morton ordering, which effectively interleaves the×and y coordinates.

The configuration instruction can relate to the widening mode. In some implementations, executing the instruction sets a field in the configuration register that represents a widening mode. The widening mode field can specify the bit width of the computation output. Setting the widening model field can cause the processor to allocate more bits to the output result.

Conversely, the widening mode field can also be used to narrow the output, for example, when the result needs to be shifted and truncated.

The configuration instruction can relate to the horizontal accumulation span. In some implementations, executing the instruction sets a field in the register that represents a horizontal accumulation span. The horizontal accumulation span field can affect the operation of matrix multiply and accumulate operations. In effect, this field specifies performing a second addition step after the multiply but prior to the accumulation. In some examples, executing the instruction causes the processor to interpret a value of the horizontal accumulation span as a direction to use a pre-add instruction during a multiply-accumulate operation. The value of the horizontal accumulation span can represent a size of each group of matrices that should be inputs to the pre-add operation. For example, if the value of the horizontal accumulation span is 2, each pair of matrices will be added together into a single matrix that will be used in the accumulation. The horizontal accumulation span effectively reduces the number of outputs that need to be written during multiply-accumulate operations

The configuration instruction can relate to an enable bit. In some examples, executing the instruction can specify an enable bit in a second configuration register. The enable bit can specify whether the processor will interpret vector instructions to be referencing vector inputs of matrix inputs.

The processor receives a vector instruction that references two vector registers (step 320). A vector register can hold vector data for processing. A vector register can have a specified number of elements. A vector register can represent, for example, a one-dimensional array of integers, logical values, characters, or floating-point numbers.

A vector instruction can cause the processor to perform an operation on two vector registers. For example, the vector instruction can cause the processor to multiply the elements of the first vector by the same-indexed elements of the second vector e.g., multiply the first element of the first vector register by the first element of the second vector register, multiply the second element of the first vector register by the second element of the second vector register, etc. As another example, the vector instruction can cause the processor to add the elements of the two vector registers together. In some implementations, the vector instruction can reference more than two vector registers. For example, the instruction can indicate that the result of multiplying (or adding, etc.) the data in the vector registers should be stored in a third vector register.

The processor reinterprets the vector instruction as a matrix instruction on matrices stored in the two vector registers (step 330). The processor reinterprets the vector registers as vectors of matrices of a specified size. For example, if a vector register has 16 elements and the specified size is 2×2, the processor reinterprets the vector register as a vector of 4 2×2 matrices. The first element of the vector becomes a matrix that contains the first four elements of the original vector register. In some examples, the data in the vector registers can be reinterpreted as a sequence of 2×2, 4×4, 8×8, or 16×16 matrices.

The processor can perform vector arithmetic on a sequence of matrices. For example, if the vector instruction is to multiply the elements of the first vector by the same-indexed elements of the second vector, the processor can multiply the first matrix of the first reinterpreted vector register by the first matrix of the second reinterpreted vector register and so on. For example, suppose the processor receives a vector multiply instruction that references two input vectors and a third, output vector. If the configuration register specifies that the input is 2×2 matrices, the processor will interpret each sequential group of four elements in the input vector registers as 2×2 matrices rather than as four scalars and will perform a matrix multiply with a corresponding group of four values in the other input vector register. This strategy can have substantial performance improvements by effectively doubling the performance of each execution lane by reusing each data input twice in the two multiply operations. Certain novel aspects of the subject matter of this specification are set forth in the claims below.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them. The computer storage medium is not, however, a propagated signal.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, subprograms, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A processor configured to implement an instruction set architecture having an instruction that in operation sets a configuration register of the processor with one or more values that cause the processor to reinterpret one or more vector instructions as matrix instructions.

2. The processor of claim 1, wherein the processor is configured to perform vector arithmetic on a sequence of matrices to reinterpret the vector instructions as matrix instructions.

3. The processor of claim 1, wherein reinterpreting a vector instruction as a matrix instruction comprises reinterpreting data in a vector register as a sequence of matrices.

4. The processor of claim 3, wherein reinterpreting the data in a vector register as a sequence of matrices comprises reinterpreting the data in the vector register as a sequence of 2×2, 4×4, 8×8, or 16×16 matrices.

5. The processor of claim 1, wherein the configuration register has a field representing a matrix width.

6. The processor of claim 5, wherein the field representing the matrix width represents an exponent N for a matrix having a width given by 2\hat{ }N.

7. The processor of claim 1, wherein the configuration register has a field representing a matrix data order.

8. The processor of claim 1, wherein the configuration register has a field representing a widening mode.

9. The processor of claim 1, wherein the configuration register has a field representing a horizontal accumulation span, wherein the processor is configured to interpret a value of the horizontal accumulation span as a directive to use a pre-add instruction during a multiply-accumulate operation.

10. The processor of claim 1, wherein the instruction set architecture specifies an enable bit in a second different configuration register that specifies whether the processor will interpret the one or more vector instructions to be referencing vector inputs or matrix inputs.

11. A method performed by a processor implementing an instruction set architecture having an instruction for setting a configuration register of the processor that controls whether vector instructions are reinterpreted as matrix instructions, the method comprising:
executing the instruction to set the configuration register;
receiving one or more vector instructions; and
based on information set in the configuration register, reinterpreting the one or more vector instructions as matrix instructions.

12. The method of claim 11, wherein reinterpreting the vector instructions as matrix instructions comprises performing vector arithmetic on a sequence of matrices.

13. The method of claim 11, wherein reinterpreting a vector instruction as a matrix instruction comprises reinterpreting data in a vector register as a sequence of matrices.

14. The method of claim 13, wherein reinterpreting the data in a vector register as a sequence of matrices comprises reinterpreting the data in the vector register as a sequence of 2×2, 4×4, 8×8, or 16×16 matrices.

15. The method of claim 11, wherein executing the instruction sets a field in the configuration register representing a matrix width.

16. The method of claim 15, wherein the field representing the matrix width represents an exponent N for a matrix having a width given by 2\hat{ }N.

17. The method of claim 11, wherein executing the instruction sets a field in the configuration register representing a matrix data order.

18. (canceled)

19. The method of claim 11, wherein executing the instruction sets a field in the configuration register representing a horizontal accumulation span, and further comprising interpreting a value of the horizontal accumulation span as a directive to use a pre-add instruction during a multiply-accumulate operation.

20. The method of claim 11, wherein the instruction set architecture specifies an enable bit in a second different configuration register that specifies whether the processor will interpret the one or more vector instructions to be referencing vector inputs or matrix inputs.

21. One or more computer storage media encoded with instructions of an instruction set architecture having an instruction for setting a configuration register to control whether a processor implementing the instruction set architecture will reinterpret vector instructions as matrix instructions, wherein the instructions being executed by the processor implementing the instruction set architecture causes the processor to perform operations comprising:
executing the instruction to set the configuration register;
receiving one or more vector instructions; and
based on information set in the configuration register, reinterpreting the one or more vector instructions as matrix instructions, reinterpreting the one or more vector instructions as matrix instructions.

22-30. (canceled)
